(19) United States
(12) Patent Application Publication
(10) Pub. No.: US 2019/0145520 A1
(43) Pub. Date: May 16, 2019

(54) Shaft Seal

(71) Applicant: Wan-Rong Kung, Kaohsiung City (TW)

(72) Inventor: Wan-Rong Kung, Kaohsiung City (TW)

(21) Appl. No.: 16/018,200

(22) Filed: Jun. 26, 2018

(30) Foreign Application Priority Data
Nov. 13, 2017 (TW) 106139200

(51) Int. Cl. F16J 15/3232; F16J 15/3252

(52) U.S. Cl. CPC F16J 15/3232; F16J 15/3252

(57) ABSTRACT

An elastomeric seal for a shaft includes a static sealing body having an outer annular surface to be engaged at a shaft hole in a housing. A radially-dynamic sealing ring is provided on an inner annular surface of the static sealing body for contacting an outer surface of the shaft. First and second dynamic sealing lips extend from an outer end surface of the static sealing body and contact a shoulder part formed at the outer surface of the shaft. The radially-dynamic sealing ring and the first dynamic sealing lip constitute a first sealing space in between. The first and second dynamic sealing lips constitute a second sealing space in between. The first and second sealing spaces help the radially-dynamic sealing ring and the first dynamic sealing lip to sustain fluid pressures inside the housing of the mechanical component for reduction of deformations.

### BACKGROUND OF THE INVENTION

### 1. Field of the Invention

The present invention relates to an elastomeric seal for a shaft or a rotatable member or element. The present invention further relates to a shaft seal installed in a shaft hole in a housing or a hole/an opening in a similar housing for a sealing effect between the housing and a rotary shaft or a shaft.

### 2. Description of the Related Art

“Lubricated Shaft Seal” disclosed in US20130175763 A1 describes a shaft seal which includes a casing and a conically-shaped sealing lip extending axially and radially toward a rotary shaft. The casing is installed in a shaft hole in a housing of a mechanical component. The conically-shaped sealing lip is mounted around an outer surface of the rotary shaft installed in the shaft hole. The conically-shaped sealing lip facing the interior of the housing is able to seal a gap between the housing (the shaft hole) of the mechanical component and the rotary shaft.

However, the conically-shaped sealing lip of the shaft seal with which the gap between the housing and the rotary shaft is sealed has to sustain fluid pressures inside the housing of the mechanical component. A deformation attributed to fluid pressures might be observed on the conically-shaped sealing lip and probably excessive such that the contact interface between the conically-shaped sealing lip and the rotary shaft is uneven. With uneven frictions worsening leakages, the shaft seal suffers poor durability.

### BRIEF SUMMARY OF THE INVENTION

It is an objective of the present invention to provide an elastomeric shaft seal for sealingly engaging a shaft which features sealing lips sustaining more pressures but bearing fewest improper deformations for a better service life. Additionally, the shaft in a housing is sealed axially, transversely, and longitudinally for fewest leakages.

To achieve this and other objectives, a shaft seal for sealingly engaging a shaft according to an embodiment of the present invention includes a static sealing body, a radially-dynamic sealing ring, first and second dynamic sealing lips, and a shoulder part. The static sealing body includes a through-hole through which the shaft extends, an inner annular surface defined by the through-hole, and an outer annular surface backing onto the inner annular surface. The static sealing body further includes an inner end surface and an outer end surface spaced from the inner end surface along an axis of the shaft. The radially-dynamic sealing ring extends toward a central direction of the static sealing body from the inner annular surface and includes a first end connected to the static sealing body and a second end extending outward from the first end. The first and second dynamic sealing lips extend outward from the outer end surface of the static sealing body axially. The first dynamic sealing lip is adjacent to the radially-dynamic sealing ring, and an included angle is formed between the first and second dynamic sealing lips. The shoulder part is formed at an outer surface of the shaft and has a lateral end surface opposite to the outer end surface of the static sealing body axially. The radially-dynamic sealing ring and the first dynamic sealing lip constitute a first sealing space in between, and the first and the second dynamic sealing lips constitute a second sealing space in between when the shaft seal is mounted around the shaft and the radially-dynamic sealing ring as well as the first and second dynamic sealing lips are securely combined with the outer surface of the shaft and the shoulder part.

In an embodiment, the second end of the radially-dynamic sealing ring extends toward the inner end surface, and the radially-dynamic sealing ring as well as the inner annular surface form an included angle less than 90 degrees in between.

In an embodiment, the radially-dynamic sealing ring includes a sealing end surface facing the first dynamic sealing lip and a terminal end surface at the second end thereof, and the terminal end surface and the sealing end surface form an acute included angle less than 90 degrees in between.

In an embodiment, a bushing ring is formed at the outer annular surface of the static sealing body. The bushing ring includes a shoulder developed at the inner end surface of the static sealing body.

In an embodiment, the bushing ring includes an outer surface provided with an elastomeric coating layer thereon.

In an embodiment, the shoulder part is formed by a side seal ring fixed on the outer surface of the shaft. The side seal ring includes a first end surface, a second end surface spaced from the first end surface axially, and an inner annular surface between the first and second end surfaces. The first end surface constitutes the lateral end surface of the shoulder part. The side seal ring further includes an annular groove in the inner annular surface, and a sealing ring is accommodated in the annular groove.

In an embodiment, the side seal ring is fixed to the shaft by a retaining ring including a positioning hole extending in a radial direction perpendicular to the axis of the shaft. A set bolt is received in the positioning hole and locked against the outer surface of the shaft to fix the side seal ring on the shaft. The outer surface of the shaft has a stepwise end surface which is abutted by the side seal ring.

In an embodiment, the lateral end surface features surface roughness ranging from 0.01 to 3.2.

The present invention will become clearer in light of the following detailed description of illustrative embodiments of this invention described in connection with the drawings.

### DESCRIPTION OF THE DRAWINGS

FIG. 1 is a sectional view of a shaft seal according to an embodiment of the present invention, with the shaft seal mounted around an outer surface of a rotary shaft.

FIG. 2 is a sectional view of the shaft seal in FIG. 1.

FIG. 3 is a schematic view of a shaft seal according to another preferred embodiment of the present invention.

FIG. 4 is a schematic view of a shaft seal according to still another preferred embodiment of the present invention.

FIG. 5 is a sectional view of a shaft seal according to a further preferred embodiment of the present invention, with the shaft seal mounted around the outer surface of the rotary shaft.

### DETAILED DESCRIPTION OF THE INVENTION

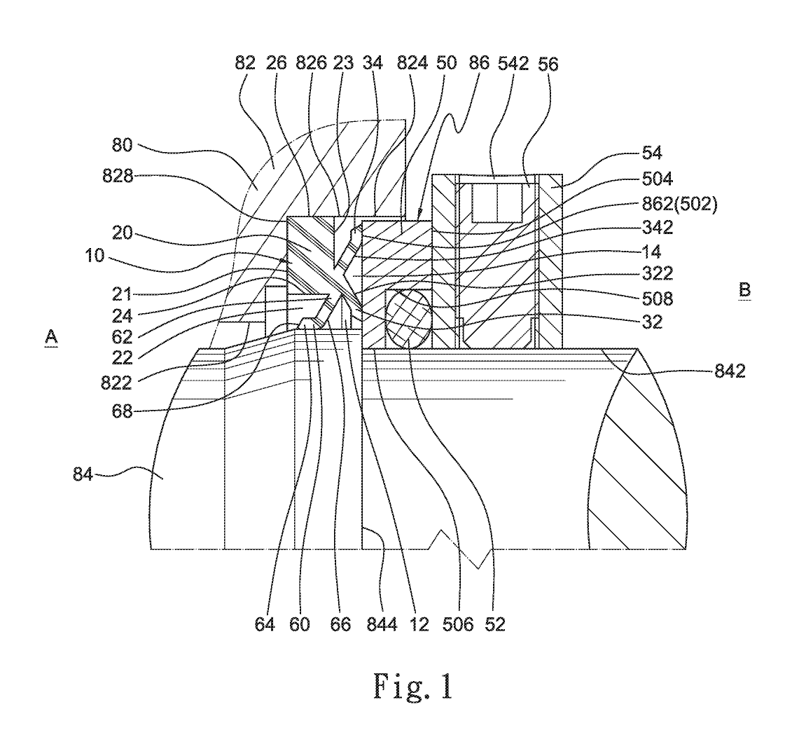

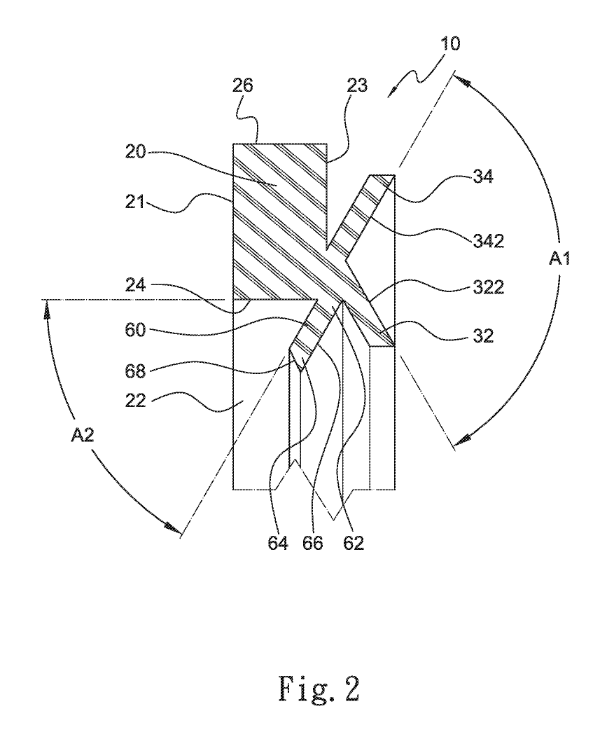

A shaft seal 10 according to a preferred embodiment of the present invention is shown in FIGS. 1 and 2 of the drawings and can be manufactured in a thermo-compression bonding process, an injection molding process or a combination thereof or other similar processes. The shaft seal 10 is accommodated in a gap between a housing 82 of a mechanical component 80 and a shaft (rotary shaft) 84. When the shaft seal 10 is installed in the gap between the static housing 82 and the dynamic shaft 84 during assembling, the side at which the shaft seal 10 is sealed in the housing 82 is called as an “inner space side” A and the other side separated from the shaft seal 10 in the housing 82 is called as an “outer space side” B.

The shaft seal 10 of the present invention includes an annular static sealing body 20 with a central through-hole 22 extending along an axis of the shaft 84. The static sealing body 20 has an inner annular surface 24 defined by the through-hole 22 and an outer annular surface 26 backing onto the inner annular surface 24. The static sealing body 20 further has an inner end surface 21 and an outer end surface 23 spaced from the inner end surface 21 along the axis of the shaft 84. The outer annular surface 26 or the inner end surface 21 constitutes a static sealing surface.

The shaft seal 10 further includes a flexible (elastomeric) radially-dynamic sealing ring 60 extending toward a central direction of the static sealing body 20 from the inner annular surface 24. The radially-dynamic sealing ring 60 includes a first end 62 connected to the static sealing body 20 and a second end 64 extending outward from the first end 62 and located in the through-hole 22. The shaft seal 10 further includes a flexible (elastomeric) first dynamic sealing lip 32 and a flexible (elastomeric) second dynamic sealing lip 34, each of which extends outward from the outer end surface 23 along the static sealing body 20 axially and radially. The first dynamic sealing lip 32 is adjacent to the inner annular surface 24 and the radially-dynamic sealing ring 60, and an included angle (A1) is formed between the first and second dynamic sealing lips 32 and 34 and is greater than 90 degrees in this embodiment. The first and second dynamic sealing lips 32 and 34 are inclined relative to the axis of the shaft 84 and develop first and second sealing end surfaces 322 and 342 along the included angle (A1), respectively. The radially-dynamic sealing ring 60 and the first and second dynamic sealing lips 32 and 34 can be combined with the static sealing body 20 in regular chemical steps or integrated with the static sealing body 20 in a molding process. In a preferred embodiment, the radially-dynamic sealing ring 60 extends toward the center of the static sealing body 20 and the inner space side A (the inner end surface 21). The radially-dynamic sealing ring 60 and the inner annular surface 24 form an acute included angle (A2) less than 90 degrees in between, and a side of the dynamic sealing ring 60 in its thickness direction develops a sealing end surface 66 facing the first dynamic sealing lip 32. The radially-dynamic sealing ring 60 has a terminal end surface 68 at the second end 64, and the terminal end surface 68 and the sealing end surface 66 form an acute included angle less than 90 degrees in between (see FIG. 2). Furthermore, the second end 64 of the radially-dynamic sealing ring 60 is less than the shaft 84 in diameter.

In an embodiment for assembling, the shaft seal 10 is installed in the mechanical component 80 properly. The housing 82 of the mechanical component 80 has a shaft hole 822 therein (see FIG. 1), and the shaft 84 extends through the shaft hole 822 and the through-hole 22 of the static sealing body 20. The shaft hole 822 has a stepped configuration with smaller and larger diameter portions, and the larger diameter portion defines a counter bore 824 formed at an outer surface of the housing 82 and having an internal annulus wall 826 and a side wall 828. When the shaft seal 10 is installed around the shaft 84, the second end 64 of the radially-dynamic sealing ring 60, which is kept away from the outer space side B, extends toward the inner space side A and is accommodated in the through-hole 22 of the static sealing body 20. Because of elastomeric material of the radially-dynamic sealing ring 60, the sealing end surface 66 of the radially-dynamic sealing ring 60 is adhered to the outer surface 842 of the shaft 84 such that the radially-dynamic sealing ring 60 and the shaft 84 constitute a traverse dynamic sealing interface in between. The outer annular surface 26 of the static sealing body 20, which is placed in the counter bore 824, is slightly greater than the internal annulus wall 826 of the counter bore 824 in diameter such that the outer annular surface 26 of the static sealing body 20 and the internal annulus wall 826 of the counter bore 824 constitute a traverse static sealing interface. With the static sealing body 20 abutting the side wall 828 of the counter bore 824, the inner end surface 21 of the static sealing body 20 and the side wall 828 of the counter bore 824 constitutes a lengthwise static sealing interface in between such that no fluid inside the housing 82 leaks from a gap between the static sealing body 20 and the counter bore 824 (the shaft hole 822).

The shaft 84 further includes a shoulder part 86 developed at the outer surface 842 of the shaft 84 and situated at the outside of the outer end surface 23 of the shaft seal 10. The shoulder part 86 has a lateral end surface 862 opposite to the outer end surface 23 of the static sealing body 20 axially. The sealing end surfaces 322 and 342 of the first and second dynamic sealing lips 32 and 34 abuts the lateral end surface 862 of the shoulder part 86 elastically such that the sealing end surfaces 322 and 342 of the first and second dynamic sealing lips 32 and 34 and the shoulder part 86 constitute a lengthwise dynamic sealing interface in between.

In the practice of the radially-dynamic sealing ring 60 and the first and second dynamic sealing lips 32 and 34, the radially-dynamic sealing ring 60 along with the first dynamic sealing lip 32 and both the outer surface 842 of the shaft 84 and the shoulder part 86 constitute a first sealing space 12 in between. The first and second dynamic sealing lips 32 and 34 and the shoulder part 86 constitute a second sealing space 14 in between. The first and second sealing spaces 12 and 14 help the radially-dynamic sealing ring 60 and the first dynamic sealing lip 32 to sustain external pressures. For example, when high-pressure fluids are carried in the housing 82 of the mechanical component 80, the radially-dynamic sealing ring 60 forced by the high-pressure fluids inside the inner space side A is deformed toward the outer space side B easily. Accordingly, leakages occur at the sealing end surface 66 of the radially-dynamic sealing ring 60 and the outer surface 842 of the shaft 84 easily. However, the first sealing space 12 is characteristic of inside pressures which prevent the radially-dynamic sealing ring 60 from excessive deformations and alleviate leakages or abrasive wears due to the deformations at the radially-dynamic sealing ring 60. Furthermore, the terminal end surface 68 and the sealing end surface 66 of the second end 64 of the radially-dynamic sealing ring 60 form an acute angle in between that reduces axial pressures of fluids inside the housing 82 imposed on the terminal end surface 68.

When any leakage occurs at the radially-dynamic sealing ring 60 which has been frayed after a long period of time, a leakage risk at the first and second dynamic sealing lips 32, 34 is reduced because the gap between the shaft hole 822 of the housing 82 and the shaft 84 is blocked by the first and second dynamic sealing lips 32 and 34 continuously and a deformation at the first dynamic sealing lip 32 attributed to fluid pressures is relieved by inside pressures of the second sealing space 14.

The first and second dynamic sealing lips 32 and 34, which are designed to constitute the first and second sealing spaces 12 and 14, are able to seal a gap between the housing 82 and the shaft 84 if any leakage occurs at the frayed radially-dynamic sealing ring 60. Moreover, the lengthwise dynamic sealing interface constituted by the first and second dynamic sealing lips 32 and 34 and the shoulder part 86 is perpendicular to an axis of the shaft hole 822 such that axial fluid pressures due to the shaft hole 822 are not applied on the lengthwise dynamic sealing interface at which any leakage attributed to fluid pressures is seldom.

For alleviated wear between the first and second dynamic sealing lips 32 and 34 and the lateral end surface 862 of the shoulder part 86, the lateral end surface 862 of the shoulder part 86 which is contacted with the first and second dynamic sealing lips 32 and 34 could be a machined end surface with low surface roughness in a preferred embodiment for better mobility, air impermeability and adhesion through accurate grinding, general grinding, polishing, ultra-accurate grinding, mirror finish grinding or electroplating in addition to existing measures for changes in materials of the first and second dynamic sealing lips 32 and 34. For that matter, the lateral end surface 862 is characteristic of surface roughness (Ra) between 0.01 and 3.2 and preferably between 0.01 and 1.6.

For easy surface finish machining of the lateral end surface 862 of the shoulder part 86 and convenient assembling/disassembling of the shaft 84, the shoulder part 86 may be formed by a side seal ring 50 fixed around the outer surface 842 of the shaft 84. The side seal ring 50 has a first end surface 502 and a second end surface 504, both of which are spaced from each other axially. The first end surface 502 constitutes the lateral end surface 862 and both the side seal ring 50 and the outer surface 842 of the shaft 84 rely on a sealing ring 52 to seal a gap in between. Preferably, the side seal ring 50 includes an annular groove 508 in an inner annular surface 506 thereof, and the sealing ring 52 is accommodated in the annular groove 508. In the case of combination of the side seal ring 50 and the shaft 84, the side seal ring 50, which can be locked in, welded to or closely fitted to the outer surface 842 of the shaft 84, is fixed to the shaft 84 by a retaining ring 54 in an embodiment as disclosed in drawings. The shaft 84 has a stepwise end surface 844 at the outer surface 842. The retaining ring 54 has a positioning hole 542 extending in a radial direction perpendicular to the axis of the shaft 84 and inserted by a set bolt 56. When the stepwise end surface 844 is abutted by the first end surface 502 of the side seal ring 50, the side seal ring 50 is clipped by the retaining ring 54 which located on the second end surface 504 of the side seal ring 50, and the retaining ring 54 fixes the side seal ring 50 on the outer surface 842 of the shaft 84 after the set bolt 56 is locked against the shaft 84.

At the side seal ring 50, the first end surface 502 which constitutes the lateral end surface 862 of the shoulder part 86 is a machined end surface with low surface roughness (Ra) ranging from 0.01 to 3.2 and preferably from 0.01 to 1.6.

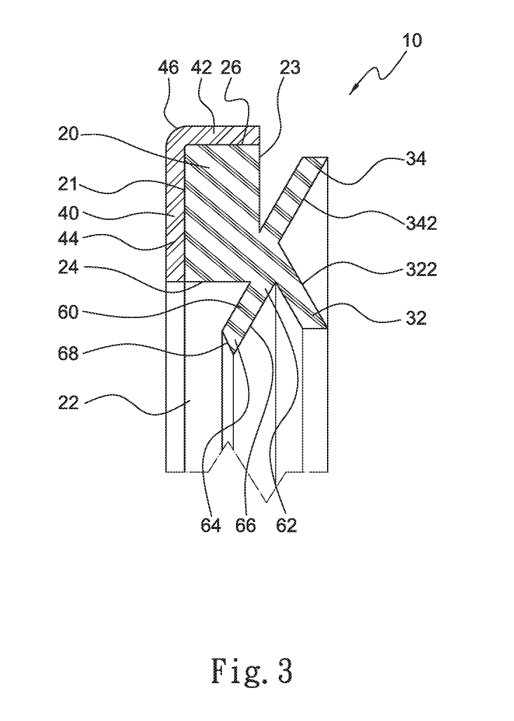

The static sealing body 20 which can be made of high-rigidity polymers is closely fitted to the counter bore 824 for a good tight-fit degree. For structural strength and fewest deformations of the static sealing body 20, the shaft seal 10 of the present invention can further includes a bushing ring 40, as shown in FIG. 3. The bushing ring 40 and the static sealing body 20 can be molded integrally through a chemical bonding process, a thermo-compression bonding process, an injection molding process or a combination thereof or other similar processes. The bushing ring 40 reinforces the overall static sealing body 20 for no deformation. In this embodiment, the bushing ring 40 includes a transverse annulus portion 42 developed at the outer annular surface 26 of the static sealing body 20 and a shoulder 44 developed at the inner end surface 21. The bushing ring 40 has an outer surface 46 which constitutes the above mentioned “static sealing interface”.

During assembling, the static sealing body 20 relies on the bushing ring 40 to be accommodated in the counter bore 824. The outer surface 46 of the transverse annulus portion 42 of the bushing ring 40 is slightly greater than the internal annulus wall 826 of the counter bore 824 in diameter. With gasket adhesives applied on the outer surface 46 of the bushing ring 40, the bushing ring 40 is closely fitted into the counter bore 824. The outer surface 46 of the bushing ring 40 constitutes the transverse and lengthwise static sealing surfaces with which fluids in the housing 82 are not leaked from a gap between the static sealing body 20 and the counter bore 824 (the shaft hole 822).

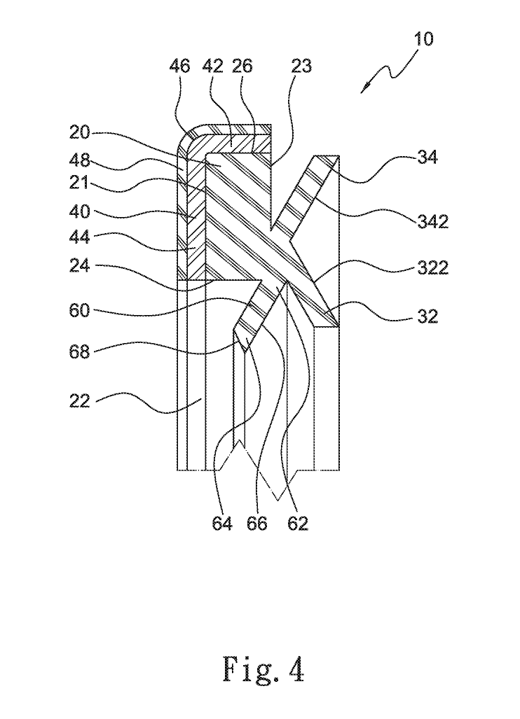

The bushing ring 40 can further includes an elastomeric coating layer 48 at the outer surface 46, as shown in FIG. 4. The elastomeric coating layer 48 is coated on either the outer surface 46 of the transverse annulus portion 42 of the bushing ring 40 or the outer surface 46 of both the transverse annulus portion 42 and the shoulder 44. The elastomeric coating layer 48 and the static sealing body 20 are molded integrally or molded through a chemical bonding process, a thermo-compression bonding process, a two-shot injection molding process or other similar processes. With the shaft seal 10 accommodated in the counter bore 824, the elastomeric coating layer 48 facilitates a good sealing effect at the counter bore 824 for development of the said “static sealing interface” by the elastomeric coating layer 48.

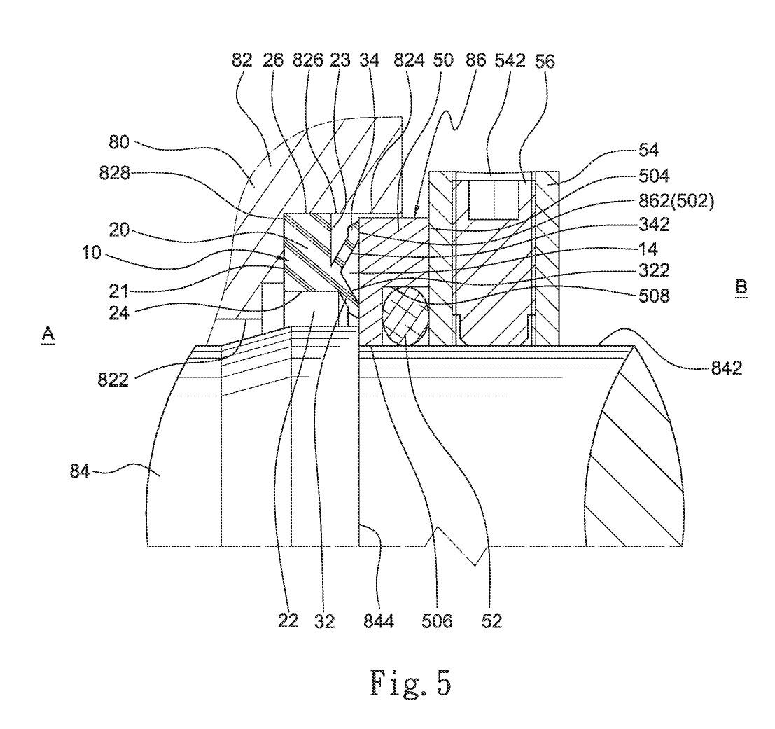

The above descriptions are the specific embodiments of the shaft seal which can be changed or modified optionally according to a design feature. For example, the lengthwise dynamic sealing interface constituted by the first and second dynamic sealing lips 32 and 34 and the shoulder part 86 developed at the outer surface 842 of the shaft 84 is perpendicular to the direction of the fluid pressures axially generated from the shaft hole 822 such that fewest leakages attributed to fluid pressures occur at the lengthwise dynamic sealing interface. As a result, the radially-dynamic sealing ring 60 in FIG. 1 can be omitted in an embodiment shown in FIG. 5. Accordingly, the scope of the invention is to be indicated by the appended claims, rather than by the foregoing description, and all changes which come within the meaning and range of equivalency of the claims are intended to be embraced therein.

1. A shaft seal for sealingly engaging a shaft, comprising:
a static sealing body including a through-hole, an inner annular surface defined by the through-hole, and an outer annular surface backing onto the inner annular surface, with the static sealing body further including an inner end surface and an outer end surface spaced from the inner end surface along an axis of the shaft;
a radially-dynamic sealing ring extending toward a central direction of the static sealing body from the inner annular surface of the static sealing body and including a first end connected to the static sealing body and a second end extending outward from the first end;
first and second dynamic sealing lips each of which extends outward from the outer end surface of the static sealing body axially, with the first dynamic sealing lip being adjacent to the radially-dynamic sealing ring, with an included angle formed between the first and second dynamic sealing lips; and
a shoulder part formed at an outer surface of the shaft and having a lateral end surface opposite to the outer end surface of the static sealing body axially;
wherein the radially-dynamic sealing ring and the first dynamic sealing lip constitute a first sealing space in between and the first and the second dynamic sealing lips constitute a second sealing space in between when the shaft seal is mounted around the shaft and the radially-dynamic sealing ring as well as the first and second dynamic sealing lips are securely combined with the outer surface of the shaft and the shoulder part.

2. The shaft seal according to claim 1, wherein the second end of the radially-dynamic sealing ring extends toward the inner end surface, and the radially-dynamic sealing ring as well as the inner annular surface form an included angle less than 90 degrees in between.

3. The shaft seal according to claim 1, wherein the radially-dynamic sealing ring includes a sealing end surface facing the first dynamic sealing lip and a terminal end surface at the second end thereof, with the terminal end surface and the sealing end surface forming an acute included angle less than 90 degrees in between.

4. The shaft seal according to claim 1, further comprising:
a bushing ring formed at the outer annular surface of the static sealing body.

5. The shaft seal according to claim 4, wherein the bushing ring includes a shoulder developed at the inner end surface of the static sealing body.

6. The shaft seal according to claim 4, wherein the bushing ring includes an outer surface provided with an elastomeric coating layer thereon.

7. The shaft seal according to claim 1, wherein the shoulder part is formed by a side seal ring fixed on the outer surface of the shaft, with the side seal ring including a first end surface, a second end surface spaced from the first end surface axially, and an inner annular surface between the first and second end surfaces, with the first end surface constituting the lateral end surface of the shoulder part.

8. The shaft seal according to claim 7, wherein the side seal ring is fixed to the shaft by a retaining ring including a positioning hole extending in a radial direction perpendicular to the axis of the shaft, with a set bolt received in the positioning hole and locked against the outer surface of the shaft to fix the side seal ring on the shaft, with the outer surface of the shaft having a stepwise end surface which is abutted by the side seal ring.

9. The shaft seal according to claim 1, wherein the lateral end surface features surface roughness ranging from 0.01 to 3.2.

10. The shaft seal according to claim 7, wherein the lateral end surface features surface roughness ranging from 0.01 to 3.2.

11. The shaft seal according to claim 7, wherein the side seal ring includes an annular groove in the inner annular surface, and a sealing ring is accommodated in the annular groove.

12. A shaft seal for sealingly engaging a shaft, comprising:
a static sealing body including an inner annular surface and an outer annular surface backing onto the inner annular surface, with the static sealing body further including an inner end surface and an outer end surface spaced from the inner end surface along an axis of the shaft;
first and second dynamic sealing lips each of which extends outward from the outer end surface of the static sealing body axially, with the first dynamic sealing lip being adjacent to the inner annular surface of the static sealing body, with an included angle formed between the first and second dynamic sealing lips; and
a shoulder part formed at an outer surface of the shaft and having a lateral end surface opposite to the outer end surface of the static sealing body axially;
wherein a dynamic sealing interface is developed when the shaft seal is mounted around the shaft and the first and second dynamic sealing lips are securely combined with the shoulder part.

13. The shaft seal according to claim 12, wherein the shoulder part is formed by a side seal ring fixed on the outer surface of the shaft, with the side seal ring including a first end surface, a second end surface spaced from the first end surface axially, and an inner annular surface between the first and second end surfaces, with the first end surface constituting the lateral end surface of the shoulder part.

14. The shaft seal according to claim 13, wherein the side seal ring is fixed to the shaft by a retaining ring including a positioning hole extending in a radial direction perpendicular to the axis of the shaft, with a set bolt received in the positioning hole and locked against the outer surface of the shaft to fix the side seal ring on the shaft, with the outer surface of the shaft having a stepwise end surface which is abutted by the side seal ring.

15. The shaft seal according to claim 12, wherein the lateral end surface features surface roughness ranging from 0.01 to 3.2.

16. The shaft seal according to claim 13, wherein the lateral end surface features surface roughness ranging from 0.01 to 3.2.

17. The shaft seal according to claim 13, wherein the side seal ring includes an annular groove in the inner annular surface, and a sealing ring is accommodated in the annular groove.
